(19) United States
(12) Patent Application Publication
(10) Pub. No.: US 2026/0163100 A1
(43) Pub. Date: Jun. 11, 2026

(54) HEATING CONTROL SYSTEM AND HEATING CONTROL METHOD

(71) Applicant: TOYOTA JIDOSHA KABUSHIKI KAISHA, Toyota-shi (JP)

(72) Inventors: Hiroki TASHIRO, Nisshin-shi (JP); Yoshiaki KIKUCHI, Toyota-shi (JP); Ryo MANO, Nisshin-shi (JP); Yuji NISHI, Nagoya-shi (JP); Keisuke ISHIKAWA, Nagakute-shi (JP)

(73) Assignee: TOYOTA JIDOSHA KABUSHIKI KAISHA, Toyota-shi (JP)

(21) Appl. No.: 19/393,850

(22) Filed: Nov. 19, 2025

(30) Foreign Application Priority Data
Dec. 11, 2024 (JP) 2024-216916

(51) Int. Cl. H01M 10/63; H01M 10/0525; H01M 10/615; H01M 10/657

(52) U.S. Cl. CPC H01M 10/63; H01M 10/615; H01M 10/657; H01M 10/0525

(57) ABSTRACT

A heating control system includes a three-phase inverter configured to be driven using electric power of a lithium ion secondary battery, a control unit configured to heat the lithium ion secondary battery by supplying current generated by the three-phase inverter to the lithium ion secondary battery, a high-frequency signal supply unit configured to supply a high-frequency signal with a frequency of 0.1 MHz or higher to the lithium ion secondary battery, a detecting unit configured to detect a value of a real part of alternating-current impedance from the lithium ion secondary battery to which the high-frequency signal has been supplied, and a calculation unit configured to calculate an amount of Li deposition in the lithium ion secondary battery from the detected value of the real part of alternating-current impedance.

### CROSS-REFERENCE TO RELATED APPLICATION

This application claims priority to Japanese Patent Application No. 2024-216916 filed on Dec. 11, 2024. The disclosure of the above-identified application, including the specification, drawings, and claims, is incorporated by reference herein in its entirety.

### BACKGROUND

### 1. Technical Field

The disclosure relates to a heating control system and a heating control method.

### 2. Description of Related Art

To reduce the degradation of the performance of lithium ion secondary batteries, it is desired to suppress the deposition of metal Li (lithium) (hereinafter, Li deposition) in lithium ion secondary batteries. However, a method of nondestructively detecting Li deposition in lithium ion secondary batteries has not been known.

In contrast, as described in Japanese Patent No. 7347451 (JP 7347451 B), the inventors developed a technique for detecting the real part of alternating-current impedance of a lithium ion secondary battery using a high-frequency signal and calculating the amount of Li deposition in the lithium ion secondary battery based on the difference between the current value and initial value of the real part of alternating-current impedance.

### SUMMARY

Incidentally, to apply ripple heating to a lithium ion secondary battery, current can be supplied to the lithium ion secondary battery. Due to the current supplied, the amount of Li deposition may increase.

The disclosure provides a heating control system and a heating control method that reduce the risk of lithium deposition due to current supplied for ripple heating.

A first aspect of the disclosure relates to a heating control system. The heating control system includes a three-phase inverter configured to be driven using electric power of a lithium-ion secondary battery, a control unit configured to heat the lithium ion secondary battery by supplying current generated by the three-phase inverter to the lithium ion secondary battery, a high-frequency signal supply unit configured to supply a high-frequency signal with a frequency of 0.1 MHz or higher to the lithium-ion secondary battery, a detecting unit configured to detect a value of a real part of alternating-current impedance from the lithium-ion secondary battery to which the high-frequency signal has been supplied, and a calculation unit configured to calculate an amount of Li deposition in the lithium-ion secondary battery from the detected value of the real part of alternating-current impedance. The control unit is configured to control the current generated by the three-phase inverter such that heating of the lithium ion secondary battery is increasingly suppressed as the calculated amount of Li deposition increases.

In the heating control system, the high-frequency signal supply unit may be configured to supply the high-frequency signal with a frequency of 0.5 MHz or higher to the lithium ion secondary battery.

In the heating control system, the current generated by the three-phase inverter may include a charging current component and a ripple current component, and the control unit may be configured to control the current generated by the three-phase inverter by increasing a frequency of the ripple current component.

In the heating control system, the current generated by the three-phase inverter may include a charging current component and a ripple current component, and the control unit may be configured to control the current generated by the three-phase inverter by reducing an amplitude of the ripple current component.

In the heating control system, the current generated by the three-phase inverter may include a charging current component and a ripple current component, and the control unit may be configured to control the current generated by the three-phase inverter by reducing supply of the ripple current component.

A second aspect of the disclosure relates to a heating control method. The heating control method includes driving a three-phase inverter using electric power of a lithium-ion secondary battery, heating the lithium ion secondary battery by supplying current generated by the three-phase inverter to the lithium ion secondary battery, supplying a high-frequency signal with a frequency of 0.1 MHz or higher to the lithium-ion secondary battery, detecting a value of a real part of alternating-current impedance from the lithium-ion secondary battery to which the high-frequency signal has been supplied, and calculating an amount of Li deposition in the lithium-ion secondary battery from the detected value of the real part of alternating-current impedance. In a period during which the lithium-ion secondary battery is heated, the current generated by the three-phase inverter is controlled such that heating of the lithium ion secondary battery is increasingly suppressed as the calculated amount of Li deposition increases.

According to the aspects of the disclosure, it is possible to reduce the amount of Li deposition using current supplied for ripple heating.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram that shows an example of the configuration of a heating control system according to an embodiment;

FIG. 2 is a graph that shows the relationship between the state of health (SOH) of a secondary battery and a change in the real part Z of alternating-current impedance in a case where a high-frequency signal with a frequency of 1 MHz is supplied to the secondary battery;

FIG. 3 is a graph that shows the relationship between the frequency of an alternating-current signal supplied to a secondary battery and the real part of alternating-current impedance detected from the secondary battery;

FIG. 4 is a graph that shows the relationship between the frequency of an alternating-current signal supplied to a secondary battery and the real part of alternating-current impedance detected from the secondary battery; and

FIG. 5 is a flowchart that shows a heating control method according to the embodiment.

### DETAILED DESCRIPTION OF EMBODIMENTS

Hereinafter, a specific embodiment of the disclosure will be described in detail with reference to the accompanying drawings. However, the disclosure is not limited to the following embodiment. For clear illustration, the following description and drawings are simplified as needed.

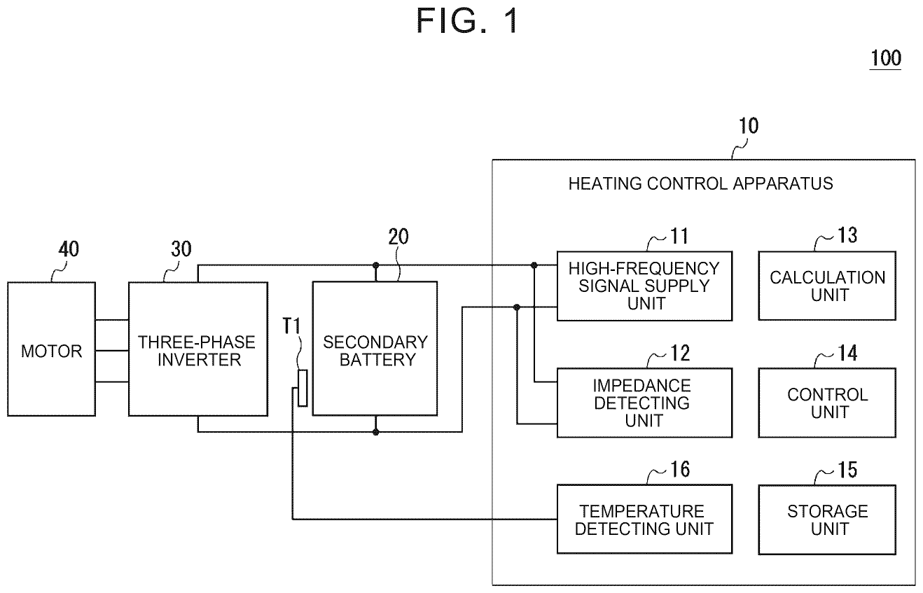

FIG. 1 is a block diagram that shows an example of the configuration of a heating control system according to the embodiment. As shown in FIG. 1, the heating control system 100 includes a heating control apparatus 10, a secondary battery 20 that is managed by the heating control apparatus 10, and a three-phase inverter 30 that is driven using electric power of the secondary battery 20. FIG. 1 also shows a motor 40 that is driven by the three-phase inverter 30.

### Configuration of Secondary Battery 20

First, the secondary battery 20 that is an object to be managed will be described. The secondary battery 20 is a lithium ion secondary battery, and includes a cell stack made up of a plurality of stacked battery cells and a case that houses the cell stack. Each of the battery cells includes a positive electrode, a negative electrode, and an ion conducting medium. The ion conducting medium is provided between the positive electrode and the negative electrode and conducts carrier ions. A separator may be further provided between the positive electrode and the negative electrode. A resin, such as polyethylene and polypropylene, is used for the separator.

For example, a sulfide including a transition metal element, an oxide including lithium and a transition metal element, or the like, is used for a positive electrode active material. Specifically, a lithium manganese composite oxide with a basic chemical composition formula of Li₍₁₋ₓ₎MnO₂ (where 0<x<1), Li₍₁₋ₓ₎Mn₂O₄, or the like, a lithium cobalt composite oxide with a basic chemical composition formula of Li₍₁₋ₓ₎CoO₂ or the like, a lithium nickel composite oxide with a basic chemical composition formula of Li₍₁₋ₓ₎NiO₂ or the like, or a lithium nickel cobalt manganese composite oxide with a basic chemical composition formula of Li₍₁₋ₓ₎NiₐCo_{b}Mn_{c}O₂ (where a+b+c=1), or the like, is used for a positive electrode active material. A material that includes other elements in addition to any one of the basic chemical composition formulas may be used for a positive electrode active material. For example, aluminum (Al) or the like is used for a current collector for the positive electrode.

For example, a composite oxide including lithium, a carbon material, or the like, is used for a negative electrode active material. Specifically, an inorganic chemical compound, such as lithium, lithium alloys, and tin chemical compounds, a carbon material capable of absorbing and releasing lithium ions, a composite oxide including a plurality of elements, a conductive polymer, or the like, is used for a negative electrode active material. Examples of the carbon material used for a negative electrode active material include cokes, glassy carbons, graphites, non-graphitizable carbons, pyrolytic carbons, and carbon fibers. Graphites, such as artificial graphite and natural graphite, are preferable. Examples of the composite oxide used for a negative electrode active material include a lithium titanium composite oxide and a lithium vanadium composite oxide. For example, copper (Cu) or the like is used for a current collector for the negative electrode.

The ion conducting medium is used as an electrolytic solution by, for example, dissolving a supporting electrolyte. Examples of the supporting electrolyte include lithium salts, such as LiPF₆ and LiBF₄. Any one of carbonates, esters, ethers, nitriles, furans, sulfolanes, and dioxolanes, or a mixture of some of them is used for a solvent for the electrolytic solution. Examples of the carbonates include cyclic carbonates such as ethylene carbonate, propylene carbonate, vinylene carbonate, butylene carbonate, and chloroethylene carbonate, and chain carbonates such as dimethyl carbonate, ethyl methyl carbonate, diethyl carbonate, ethyl-n-butyl carbonate, methyl-t-butyl carbonate, di-i-propyl carbonate, and t-butyl-i-propyl carbonate. Alternatively, a solid ionic conductive polymer, an inorganic solid electrolyte, a composite material of an organic polymer electrolyte and an inorganic solid electrolyte, or an inorganic solid powder bound by an organic binder may be used for the ion conducting medium.

Incidentally, in the secondary battery 20, Li metal deposits on the electrode surface of each battery cell as a result of repeated charging. Li deposition progresses as charging power increases to accelerate the rate of charge, and degrading the state of health (SOH) of the secondary battery 20.

The SOH of the secondary battery 20 refers to the percentage of the current full charge capacity where the initial full charge capacity of the secondary battery 20 is 100%. Therefore, it is desirable to control the ripple heating of the secondary battery 20 while suppressing Li deposition in the secondary battery 20.

### Configuration of Heating Control Apparatus 10

Next, the heating control apparatus 10 that manages the secondary battery 20 will be described. As shown in FIG. 1, the heating control apparatus 10 includes a high-frequency signal supply unit 11, an impedance detecting unit 12, a calculation unit 13, a control unit 14, and a storage unit 15. The heating control apparatus 10 manages the charge of the secondary battery 20 that is an object to be managed. The heating control apparatus 10 calculates the amount of Li deposition in the secondary battery 20 and performs feedback control on current IA generated by the three-phase inverter 30 based on the calculation result. It is advisable for the heating control apparatus 10 to further include a temperature detecting unit 16.

Here, the heating control apparatus 10 is hardware and includes not only the storage unit 15, such as a random access memory (RAM) and a read only memory (ROM), in which various programs and data are stored, but also a computing unit, such as a central processing unit (CPU) (not shown). In other words, the heating control apparatus 10 has the function of a computer and executes various processes based on the various programs and the like.

Therefore, in FIG. 1, the functional blocks of the high-frequency signal supply unit 11, impedance detecting unit 12, calculation unit 13, and control unit 14 that make up the heating control apparatus 10 may be composed of a central processing unit (CPU), a memory, and other circuits from a hardware perspective, and may be implemented by programs and the like loaded on the memory from a software perspective. In other words, each of the functional blocks can be implemented in various forms through the hardware or software of a computer, or a combination of the hardware and the software.

The high-frequency signal supply unit 11 supplies a high-frequency signal to the secondary battery 20 to detect the amount of Li deposition. More specifically, the high-frequency signal supply unit 11 supplies a high-frequency signal with a frequency of 0.1 MHz or higher to the secondary battery 20. The high-frequency signal is preferably a high-frequency signal with which a value of the real part of alternating-current impedance, which is 10 or more times due to skin effect than a value of the real part Z of alternating-current impedance, which is detected when an alternating-current signal with a frequency of 1 kHz is supplied to the secondary battery 20. Specifically, the frequency of the high-frequency signal is preferably 0.5 MHz or higher.

When a high-frequency signal with such a frequency is supplied to the secondary battery 20, the diffusion, reaction, and movement of lithium ions in each battery cell of the secondary battery 20 cannot keep up. Therefore, due to the skin effect, the current of the high-frequency signal flows along the electrode surface of each battery cell where lithium is likely to deposit.

When the SOH degrades without Li deposition from an initial state, that is, a state where the amount of Li deposition is substantially zero, the real part Z of alternating-current impedance remains unchanged. When Li deposits, the real part Z of alternating-current impedance reduces. As the amount of Li deposition increases, the electric conductivity of the electrode surface of each battery cell increases, with the result that the value of the real part Z of alternating-current impedance reduces. Here, because a large amount of current concentrates in the highly conductive Li metal, a magnetic field changes around an Li deposition region, and, as a result, eddy current occurs. The eddy current causes losses in current collector foils and conductive parts of the electrodes; however, losses of the battery are reduced as a whole. Therefore, as the amount of Li deposition increases, a change in the magnetic field increases, and, accordingly, eddy current increases, with the result that the value of the real part Z reduces. Therefore, the amount of Li deposition in the secondary battery 20 can be calculated from a change in the real part Z of alternating-current impedance (the difference between a detected value and an initial value) detected from the secondary battery 20 to which a high-frequency signal has been supplied. Furthermore, the SOH of the secondary battery 20 can also be estimated based on the amount of Li deposition.

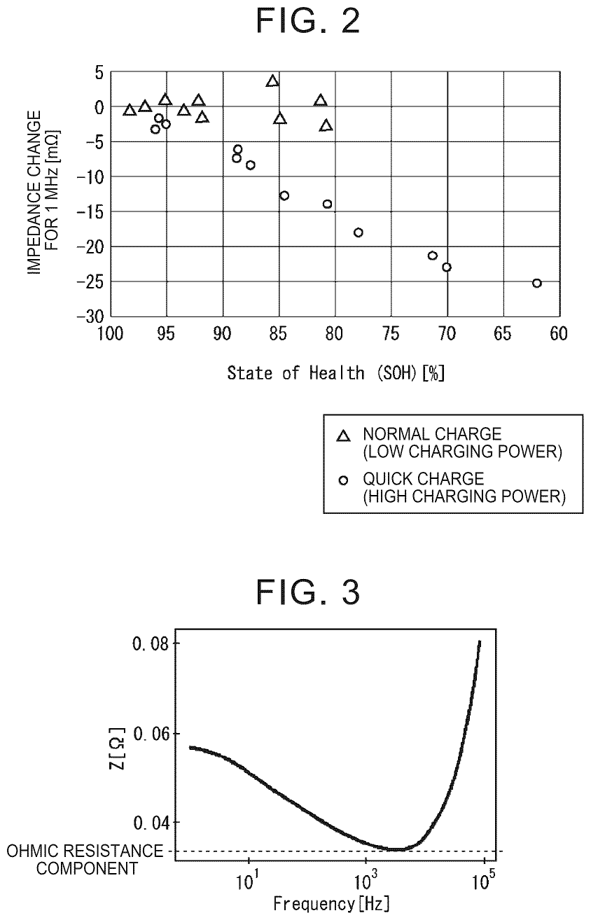

Here, FIG. 2 is a graph that shows the relationship between the SOH of the secondary battery 20 and a change in the real part Z of alternating-current impedance (the difference between a detected value and an initial value) in a case where a high-frequency signal with a frequency of 1 MHz is supplied to the secondary battery 20.

As shown by the triangle marks in FIG. 2, in the case of normal charge with low charging power, the amount of Li deposition is small even when charging is repeated. Therefore, even when the degradation of the SOH progresses due to other factors, the change in the real part Z of alternating-current impedance remains small. In other words, the detected value of the real part Z of alternating-current impedance is maintained at a high value.

On the other hand, as indicated by the circle marks in FIG. 2, in the case of quick charge with high charging power, the amount of Li deposition increases when charging is repeated, and, accordingly, the degradation of the SOH progresses, and the change in the real part Z of alternating-current impedance is large. In other words, the detected value of the real part Z of alternating-current impedance is low. When battery degradation due to Li deposition is dominant among the causes of battery degradation, the amount of Li deposition can be derived from the SOH. Alternatively, the SOH can be derived from the amount of Li deposition.

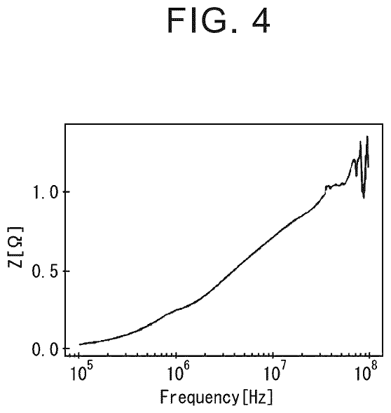

FIG. 3 and FIG. 4 are graphs that show the relationship between the frequency of an alternating-current signal supplied to the secondary battery 20 and the real part of alternating-current impedance detected from the secondary battery 20. FIG. 3 shows the value of the real part Z of alternating-current impedance in a case where an alternating-current signal with a frequency of 1 kHz to 100 kHz is supplied to the secondary battery 20. FIG. 4 shows the value of the real part Z of alternating-current impedance in a case where an alternating-current signal with a frequency of 100 kHz to 100 MHz is supplied to the secondary battery 20.

As shown in FIG. 3, when an alternating-current signal with a frequency of near 1 kHz is supplied to the secondary battery 20, the value of the real part Z of alternating-current impedance shows a minimum value. This impedance component represents an ohmic resistance component. As shown in FIG. 3 and FIG. 4, as the frequency of the alternating-current signal supplied to the secondary battery 20 increases, the flow of current concentrates on the electrode surface of each cell due to the skin effect, with the result that the value of the real part Z of alternating-current impedance increases.

Therefore, the high-frequency signal supply unit 11 supplies the secondary battery 20 with a high-frequency alternating-current signal (that is, a high-frequency signal) with which a sufficiently high value of the real part Z of alternating-current impedance compared to the ohmic resistance component is detected.

The impedance detecting unit 12 detects the value of the real part Z of alternating-current impedance from the secondary battery 20 to which the high-frequency signal has been supplied. As described above, current with a high-frequency signal, supplied from the high-frequency signal supply unit 11 to the secondary battery 20, flows along the electrode surface (Li deposition region) of each battery cell of the secondary battery 20 due to the skin effect. Even in cases where Li metal is electrically isolated from the negative electrode and enters a float state after Li deposition, current flows on the Li metal due to inductive coupling and electric field coupling. Therefore, the impedance detecting unit 12 can detect the real part Z of alternating-current impedance corresponding to the amount of Li deposition.

The calculation unit 13 calculates the amount of Li deposition in the secondary battery 20 based on the difference between the current value of the real part Z of alternating-current impedance, detected by the impedance detecting unit 12, and the initial value of the real part Z of alternating-current impedance of the secondary battery 20. Specifically, the calculation unit 13 calculates a smaller amount of Li deposition as the detected value of the real part Z of alternating-current impedance increases and as the difference from the initial value reduces. On the other hand, the calculation unit 13 calculates a larger amount of Li deposition as the detected value of the real part Z of alternating-current impedance reduces and as the difference from the initial value increases.

The initial value of the real part Z of alternating-current impedance of the secondary battery 20 that is an object to be managed is stored in, for example, the storage unit 15. Map information that represents the relationship between the amount of Li deposition and the difference (change) between the current value (detected value) and initial value of the real part Z of alternating-current impedance of each type of secondary battery may be stored in the storage unit 15.

This map information is, for example, information obtained from experiments or the like in advance and may be updated as needed based on information detected from the secondary battery 20 that is an object to be managed. When map information is used, the calculation unit 13 extracts the amount of Li deposition corresponding to the value of the real part Z of alternating-current impedance, detected by the impedance detecting unit 12, from the map information stored in the storage unit 15.

The temperature detecting unit 16 detects the temperature of the secondary battery 20. For example, the temperature detecting unit 16 detects the temperature of one or more of the plurality of battery cells that make up the secondary battery 20 using one or more thermistors T1. The temperature detecting unit 16 calculates the resistance value of each of the plurality of battery cells from the cell voltage of a corresponding one of the plurality of battery cells. Then, the temperature detecting unit 16 calculates the difference between the amount of heat generation of each of the plurality of battery cells and the amount of heat generation of the battery cell to which the thermistor T1 is attached based on the difference between the calculated resistance value of each of the plurality of battery cells and the resistance value of the battery cell to which the thermistor T1 is attached, and estimates the temperature of each of the plurality of battery cells from the calculation results.

The control unit 14 controls the ripple heating of the secondary battery 20 based on the amount of Li deposition calculated by the calculation unit 13. Specifically, the control unit 14 needs to suppress the progression of Li deposition as the amount of Li deposition calculated by the calculation unit 13 increases, so the control unit 14 controls current IA generated by the three-phase inverter 30 to suppress the ripple heating. With this configuration, the ripple heating of the secondary battery 20 can be suppressed. As a result, it is possible to suppress Li deposition in the secondary battery 20.

Specifically, first, the control unit 14 causes the three-phase inverter 30 to generate current IA. The current IA generated by the three-phase inverter 30 is supplied to the secondary battery 20. As a result, the secondary battery 20 starts ripple heating.

The current IA may be an alternating current with a predetermined frequency. Specifically, the current IA includes a charging current component Ic and a ripple current component Ir. The current value of the charging current component Ic just needs to be determined in consideration of a magnitude necessary to charge the secondary battery 20. The voltage value of the charging current component Ic is constant over time. The ripple current component Ir just needs to be determined in consideration of a magnitude necessary to heat the secondary battery 20. The voltage value of the ripple current component Ir fluctuates periodically. It is advisable for the control unit 14 to determine the frequency and amplitude of the ripple current component Ir based on the temperature of the secondary battery 20, detected by the temperature detecting unit 16, during the ripple heating of the secondary battery 20. It is advisable for the control unit 14 to increase the frequency of the ripple current component Ir in the case of constant voltage operation as the temperature of the secondary battery 20, detected by the temperature detecting unit 16, increases during the ripple heating of the secondary battery 20. It is advisable for the control unit 14 to reduce the amplitude of the ripple current component Ir as the temperature of the secondary battery 20, detected by the temperature detecting unit 16, increases during the ripple heating of the secondary battery 20.

When the amount of Li deposition, calculated by the calculation unit 13, has increased, it is advisable for the control unit 14 to increase the frequency of the ripple current component Ir. When the amount of Li deposition, calculated by the calculation unit 13, has increased, it is advisable for the control unit 14 to reduce the amplitude of the ripple current component Ir. By increasing the frequency of the ripple current component Ir and reducing the amplitude of the ripple current component Ir, the ripple heating of the secondary battery 20 can be suppressed.

When the amount of Li deposition, calculated by the calculation unit 13, has increased (when the control unit 14 determines that the amount of Li deposition is greater than or equal to a predetermined threshold), it is advisable for the control unit 14 to reduce the supply of the ripple current component Ir. Specifically, the control unit 14 may control the current IA by stopping the supply of the ripple current component Ir. When the control unit 14 stops the supply of the ripple current component Ir, the current IA is equal in magnitude to the current value of the charging current component Ic. By reducing the supply of the ripple current component Ir, the ripple heating of the secondary battery 20 can be suppressed.

When the amount of Li deposition, calculated by the calculation unit 13, has increased (when the control unit 14 determines that the amount of Li deposition is greater than or equal to a predetermined threshold), it is advisable for the control unit 14 to reduce the charging current component Ic. It is advisable that the reduced value of the charging current component Ic is greater than or equal to a current value at which it is sufficient to heat the secondary battery 20. It is advisable to determine such a current value by conducting experiments in advance. By reducing the charging current component Ic, the ripple heating of the secondary battery 20 can be suppressed.

### Heating Control Method

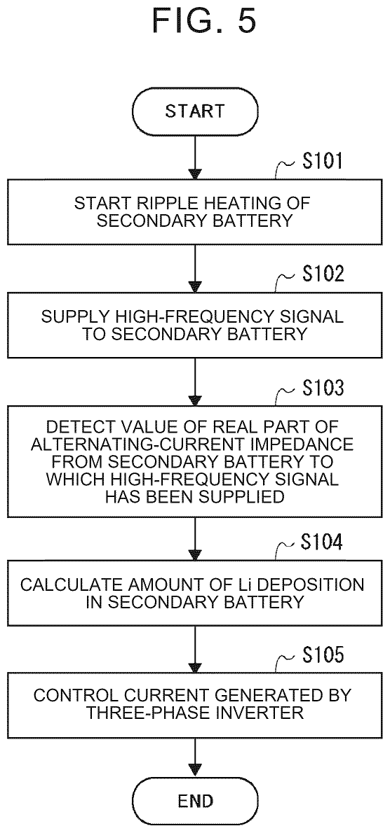

Next, the heating control method, that is, the operation of the heating control apparatus 10, according to the present embodiment will be described with reference to FIG. 5. FIG. 5 is a flowchart that shows the heating control method according to the embodiment.

First, the heating control apparatus 10 starts the ripple heating of the secondary battery 20 (step S101). Specifically, the secondary battery 20 supplies electric power to the three-phase inverter 30 to drive the three-phase inverter 30. The secondary battery 20 is heated by supplying the current IA generated by the three-phase inverter 30 to the secondary battery 20. The heating control apparatus 10 continues to perform the ripple heating of the secondary battery 20 from the next step S102.

Subsequently, the heating control apparatus 10 supplies the secondary battery 20 with an alternating-current signal with a high frequency (high-frequency signal) to such an extent that the diffusion, reaction, and movement of lithium ions in each battery cell of the secondary battery 20 cannot keep up (step S102). For example, the high-frequency signal supply unit 11 supplies a high-frequency signal with a frequency of 0.1 MHz or higher to the secondary battery 20.

Subsequently, the heating control apparatus 10 detects the value of the real part Z of alternating-current impedance from the secondary battery 20 to which the high-frequency signal has been supplied (step S103).

Subsequently, the heating control apparatus 10 calculates the amount of Li deposition in the secondary battery 20 from the detected value of the real part Z of alternating-current impedance (step S104). For example, the heating control apparatus 10 extracts the amount of Li deposition corresponding to the detected value of the real part Z of alternating-current impedance from the map information stored in the storage unit 15. Basically, the heating control apparatus 10 calculates a smaller amount of Li deposition as the detected value of the real part Z of alternating-current impedance increases, and calculates a larger amount of Li deposition as the detected value of the real part Z of alternating-current impedance reduces.

Finally, the heating control apparatus 10 controls the current IA generated by the three-phase inverter 30 based on the calculated amount of Li deposition (step S105). For example, when the calculated amount of Li deposition is small, the progression of Li deposition is suppressed, so the heating control apparatus 10 maintains the current IA as is or controls the current IA such that the current IA increases. It is more necessary to suppress the progression of Li deposition as the calculated amount of Li deposition increases, so the heating control apparatus 10 executes control such that the ripple heating of the secondary battery 20 is suppressed.

In this way, the heating control apparatus 10 according to the disclosure is capable of setting the largest possible current IA at which efficient charging in the shortest charging time while suppressing Li deposition in the secondary battery 20. In other words, the heating control apparatus 10 according to the disclosure is capable of setting the current IA for the secondary battery 20 to an appropriate value according to the amount of Li deposition, without setting an excessively low current IA, so it is possible to achieve efficient ripple heating of the secondary battery 20.

The control unit 14 may correct the temperature of the secondary battery 20, detected by the temperature detecting unit 16, so that the temperature of the secondary battery 20, detected by the temperature detecting unit 16, gradually increases with an increase in the amount of Li deposition. With this configuration, the ripple heating of the secondary battery 20 can be suppressed.

In the disclosure, the case where the temperature detecting unit 16 detects the temperature of the secondary battery 20 using the thermistor T1 and each cell voltage has been described; however, the configuration is not limited thereto. For example, the temperature detecting unit 16 may be configured to detect the battery temperature of the thermistor T1 instead of detecting the temperature of the secondary battery 20.

The disclosure is not limited to the above-described embodiment and may be modified as needed without departing from the scope of the disclosure. The disclosure may be implemented by appropriately combining the embodiment and its examples.

What is claimed is:

1. A heating control system comprising:
a three-phase inverter configured to be driven using electric power of a lithium ion secondary battery;
a control unit configured to heat the lithium ion secondary battery by supplying current generated by the three-phase inverter to the lithium ion secondary battery;
a high-frequency signal supply unit configured to supply a high-frequency signal with a frequency of 0.1 MHz or higher to the lithium ion secondary battery;
a detecting unit configured to detect a value of a real part of alternating-current impedance from the lithium ion secondary battery to which the high-frequency signal has been supplied; and
a calculation unit configured to calculate an amount of Li deposition in the lithium ion secondary battery from the detected value of the real part of alternating-current impedance, wherein
the control unit is configured to control the current generated by the three-phase inverter such that heating of the lithium ion secondary battery is increasingly suppressed as the calculated amount of Li deposition increases.

2. The heating control system according to claim 1, wherein the high-frequency signal supply unit is configured to supply the high-frequency signal with a frequency of 0.5 MHz or higher to the lithium ion secondary battery.

3. The heating control system according to claim 1, wherein:
the current generated by the three-phase inverter includes a charging current component and a ripple current component; and
the control unit is configured to control the current generated by the three-phase inverter by increasing a frequency of the ripple current component.

4. The heating control system according to claim 1, wherein:
the current generated by the three-phase inverter includes a charging current component and a ripple current component; and
the control unit is configured to control the current generated by the three-phase inverter by reducing an amplitude of the ripple current component.

5. The heating control system according to claim 1, wherein:
the current generated by the three-phase inverter includes a charging current component and a ripple current component; and
the control unit is configured to control the current generated by the three-phase inverter by reducing supply of the ripple current component.

6. The heating control system according to claim 1, wherein:
the control unit is configured to cause the three-phase inverter to generate current including a charging current component and a ripple current component using electric power of the lithium ion secondary battery; and
the control unit is configured to control the three-phase inverter such that a frequency of the ripple current component increases as the calculated amount of Li deposition increases.

7. The heating control system according to claim 1, wherein:
the three-phase inverter is configured to generate current including a charging current component and a ripple current component using electric power of the lithium ion secondary battery; and
the control unit is configured to control the three-phase inverter such that an amplitude of the ripple current component reduces as the calculated amount of Li deposition increases.

8. The heating control system according to claim 1, wherein:
the three-phase inverter is configured to generate current including a charging current component and a ripple current component using electric power of the lithium ion secondary battery;
the control unit is configured to determine whether the calculated amount of Li deposition is greater than or equal to a predetermined threshold; and
the control unit is configured to control the three-phase inverter to stop supply of the ripple current component in response to a determination that the calculated amount of Li deposition is greater than or equal to the predetermined threshold.

9. The heating control system according to claim 1, wherein:
the three-phase inverter is configured to generate current including a charging current component and a ripple current component using electric power of the lithium ion secondary battery;
the control unit is configured to determine whether the calculated amount of Li deposition is greater than or equal to a predetermined threshold; and
the control unit is configured to control the three-phase inverter to reduce the charging current component in response to a determination that the calculated amount of Li deposition is greater than or equal to the predetermined threshold.

10. A heating control method comprising:
driving a three-phase inverter using electric power of a lithium ion secondary battery;
heating the lithium ion secondary battery by supplying current generated by the three-phase inverter to the lithium ion secondary battery;
supplying a high-frequency signal with a frequency of 0.1 MHz or higher to the lithium ion secondary battery;
detecting a value of a real part of alternating-current impedance from the lithium ion secondary battery to which the high-frequency signal has been supplied; and
calculating an amount of Li deposition in the lithium ion secondary battery from the detected value of the real part of alternating-current impedance, wherein
in a period during which the lithium ion secondary battery is heated, the current generated by the three-phase inverter is controlled such that heating of the lithium ion secondary battery is increasingly suppressed as the calculated amount of Li deposition increases.
